(19) United States
(12) Patent Application Publication
(10) Pub. No.: US 2025/0187285 A1
(43) Pub. Date: Jun. 12, 2025

(54) ISOSTATIC PRESS APPARATUS AND METHOD FOR USE IN MANUFACTURE OF A BATTERY

(71) Applicant: Solid Power Operating, Inc., Louisville, CO (US)

(72) Inventor: Joshua Buettner-Garrett, Arvada, CO (US)

(21) Appl. No.: 18/974,400

(22) Filed: Dec. 9, 2024

Related U.S. Application Data
(60) Provisional application No. 63/607,512, filed on Dec. 7, 2023.

(51) Int. Cl. B30B 11/00; H01M 4/04

(52) U.S. Cl. CPC B30B 11/001; H01M 4/043; H01M 4/0471

(57) ABSTRACT

Systems and methods of producing a solid-state battery cell using an isostatic press system to apply a substantially uniaxial load on the flat surfaces of the cell, while limiting or eliminating the pressure applied to the sides and outside of the cell to minimize or reduce damage to those portions of the cell is provided. The substantially uniaxial force is generally perpendicular to the large planar surface(s) of the cell and portion of the cell being laminated or densified. A cell housing, configured for the number, size and thickness of cells to be processed, is provided that includes one or more receptacles for battery cells. The receptacles of the housing may have a shape and depth to receive individual battery cells or some portion thereof. The housing and the cell structures within the receptacles may be placed in a vacuum sealed sleeve to protect the cells from damage.

### CROSS-REFERENCE TO RELATED APPLICATIONS

This application is related to and claims priority under 35 U.S.C. § 119(e) from U.S. Patent Application No. 63/607,512 filed Dec. 7, 2023, titled “Isostatic Press Apparatus and Method for Use in Manufacture of Battery,” the entire contents of which is incorporated herein by reference for all purposes.

### TECHNICAL FIELD

Various embodiments described herein relate to the field of solid-state primary and secondary electrochemical cells, electrodes, and electrode materials, and more particularly to a fixture for supporting the same for processing in an isostatic press.

### BACKGROUND AND INTRODUCTION

The ever-increasing number and diversity of mobile devices, the evolution of hybrid/electric automobiles, and the ongoing evolution of countless battery powered devices is driving ever greater need for battery technologies with improved reliability, capacity, thermal characteristics, lifetime and recharge performance. Currently, although lithium solid-state battery technologies offer potential increases in safety, packaging efficiency, and enable new high-energy chemistries as compared to other types of batteries, improvements in battery technologies generally and particularly solid-state battery technologies are needed, including improvements in production efficiency.

In solid-state batteries, which use a solid electrolyte in place of a liquid electrolyte, it is often necessary to densify the electrolyte particles and press the anode and cathode layers to the electrolyte layer—sometimes also referred to as a separator layer—to achieve optimum performance of the assembled battery. Densification and/or lamination is often achieved by mechanical means, such as a linear press or calendar press. Conventional techniques, however, face challenges with production level scaling, application of uniform pressures on the cell layers, among others.

It is with these observations in mind, among others, that various aspects of the present disclosure were conceived.

### SUMMARY

One aspect of the present disclosure relates to a method for laminating layers of an electrode of a battery cell. The method may include the operations of loading a cell stack comprising a plurality of layers into a receptacle of a housing, which may also be considered a fixture, the receptacle shaped to receive and support the cell stack and pressurizing, through a warm isostatic press (WIP), the cell stack, the fluid pressurization from the WIP applying a pressing force on the cell stack to laminate layers of the stack and/or densify at least one of the plurality of layers of the cell stack.

Another aspect of the present disclosure relates to device for laminating layers of a battery cell. The device may include a warm isostatic press (WIP) comprising a pressurizing fluid and a housing, which may also be considered a fixture, comprising a plurality of receptacles. Each of the plurality of receptacles may be shaped to receive a cell within the housing when loaded within a corresponding receptacle of the housing. The housing may also be located within the pressurizing fluid of the WIP to laminate layers of the cell and/or densify at least one layer of the cell stack. The cell structure, whether pouched or not, along with the housing may be positioned in a sleeve, which may be vacuum sealed, to encase the housing and the supported cell structure with the isostatic press. The presence of the sleeve protects the cell from the liquid in the press and may also help facilitate, in combination with the how the fixture orients and supports the cell stacks, the pressure of the fluid being substantially uniaxial pressure on a surface or opposing surface of the cell for lamination and or densification perpendicular to the planes of the various layers of the cell structure.

Another aspect of the present disclosure may involve a method for applying force to layers of an electrode of a battery cell, where the method comprises loading a first cell stack comprising a plurality of layers into a first receptacle of a housing, the receptacle shaped to receive and support the first cell stack, and pressurizing, through an isostatic press, the first cell stack, the isostatic press applying a uniaxial pressing force across the cell stack. In some instances, the first receptable is on a first side of the housing and a second receptable is on a second side of the housing, the first side of the housing opposite the second side of the housing, the first receptacle separated by a planar wall from the second receptacle, and the method further comprises loading a second cell stack in the second receptacle, and pressurizing, through the isostatic press, the first cell stack and the second cell stack, the pressurizing providing the pressing force across the first cell stack and the second cell stack for at least one of lamination and densification.

The method may further involve covering at least a portion of the housing including the first receptacle and the first cell stack with a waterproof sleeve prior to pressurizing the cell stack. In some instances, the method may further involve vacuum sealing the housing within the waterproof sleeve.

Another aspect of the present disclosure involves an apparatus for applying force to a battery cell, where the apparatus comprises a housing comprising a first receptacle, the first receptacle shaped to receive a first cell stack, the housing configured to be positioned within an isostatic press, the receptacle further shaped to orient the first cell stack such that a substantially uniaxial force will be applied across a surface of the cell stack when the isostatic press is pressurized.

In one embodiment, the first receptacle is on a first side of the housing, and the housing further comprises a second receptacle on a second side of the housing, the first side of the housing opposite the second side of the housing, the second receptacle shaped to receive a second cell stack, the second receptacle further shaped to orient the second cell stack such that a substantially uniaxial force will be applied across a surface of the second cell stack when the isostatic press is pressurized.

In some arrangements, the first receptacle includes a planar floor on which a surface of the first cell stack may be positioned, the planar floor providing a counter uniaxial force on the first cell stack when the isostatic press is pressurized. In some specific arrangements, the first receptacle on the first side of the housing aligns with the second receptacle on the second side of the housing.

In some specific arrangements, the cell stack comprises a pouch cell, the first receptacle comprises a portion of a first depth dimensioned to receive a portion of the pouch cell to receive the uniaxial force and an extending portion dimensioned to receive a tab of the pouch cell.

The apparatus may further include a waterproof sleeve, the waterproof sleeve sealable around at least a portion of the housing and the first receptacle to prevent the pressurized fluid of the isostatic press from contacting the first cell stack when loaded in the first receptacle. The sleeve further blocking access to fluid so that fluid only pressurized the surfaces, e.g., flat planar surface, for lamination and or densification where the force from pressurizing the press is substantially perpendicular to the planar surface and/or uniaxial.

In some arrangements, the first receptacle comprises an opening in which the first cell stack is retained, the receptacle further shaped to orient the first cell stack such that an opposing substantially uniaxial force will be applied across a second opposing surface of the cell stack when the isostatic press is pressurized such that the substantially uniaxial force and the opposing substantially uniaxial force are applied to the first cell stack simultaneously. In cases where the first cell stack is a pouch cell, the opening is dimensioned such a sealed periphery of pouch cell rests on a surface of the housing surrounding the opening of the receptacle.

These and other aspects of the disclosure are described in additional detail in the description that follows.

### BRIEF DESCRIPTION OF THE DRAWINGS

FIGS. 1A-1C are side views of example battery cells, according to aspects of the present disclosure.

FIG. 2A is an overhead view of a first housing for applying substantially uniaxial force from the pressure within the press to a plurality of solid-state battery cells within an isostatic press, according to aspects of the present disclosure.

FIG. 2B is a cross-section side view of a receptacle of the first housing for applying substantially uniaxial pressure to a plurality of solid-state battery cells within an isostatic press, according to aspects of the present disclosure.

FIG. 3A is a cross-section view of a receptacle of a second housing for applying substantially uniaxial pressure to a plurality of solid-state battery cells within an isostatic press, according to aspects of the present disclosure.

FIG. 3B is an overhead view of a solid-state battery cell with a tab protection strip, according to aspects of the present disclosure.

FIG. 4 is a flowchart of a method for utilizing a housing for applying substantially uniaxial pressure to a plurality of solid-state battery cells within an isostatic press, according to aspects of the present disclosure.

FIG. 5A is a diagram illustrating an isostatic press applying pressure to a solid-state battery cell located within a protective pouch to laminate and/or densify the layers of the cell, according to aspects of the present disclosure.

FIG. 5B is a diagram illustrating an isostatic press applying pressure to a solid-state battery cell located within a vacuum-sealed protective pouch to laminate and/or densify the layers of the cell, according to aspects of the present disclosure.

FIG. 6 is a diagram illustrating a cross-section view of a frame for holding a solid-state battery cell within an isostatic press such that a pressure force is applied to a top and bottom region of the solid-state battery cell, according to aspects of the present disclosure.

FIG. 7 is a diagram illustrating an overhead view of the housing of FIG. 6 for applying opposing uniaxial pressure to opposing surfaces of a solid-state battery cell within an isostatic press, according to aspects of the present disclosure.

### DETAILED DESCRIPTION

Solid-state battery cells use solid electrodes and electrolytes, instead of liquid electrolyte layers, to create potentially safer batteries with higher energy densities. In general, the battery cell often comprises a layered structure that includes an anode and a cathode separated by a solid electrolyte. The layered structure, which may include multiple layered units of anode, electrolyte, and cathode. In some cases, the layered structure or stack is encased in a flexible laminate structure, which may be referred to as a pouch. A flexible pouch is used in some solid-state batteries because the encased cell structure expands and contracts during charge and discharge, and the flexible pouch accommodates it. In many instances, the pouched cell defines opposing planar surfaces with planar tabs, one connected to the anode(s) and one connected to the cathode(s) of the interior cell stack by way of anode and cathode current collectors, with the tabs extending from a side or opposing sides of the pouch, although other arrangements are possible. Aspects of the present disclosure apply to a battery cell stack (prior to be encased in a pouch) and/or a pouched battery cell, or other discrete electrode or cell arrangements where lamination and/or densification is needed or beneficial.

Aspects of the present disclosure involve the application of a pressure to the cell stack to laminate the stack layers together and/or densify the materials of the various layers. In one aspect of the present disclosure, an isostatic press may be used to apply a uniform pressure to the layered cell structure as opposed to or in addition to any densification that may take place. In general, the implementations discussed herein may include any type of isostatic pressing device. In one particular implementation, a warm isostatic press (WIP) may be utilized. Although discussed herein as including a WIP, it should be appreciated that the devices, methods, systems, and the like discussed may apply to any isostatic press. Thus, although the term “warm, isostatic press” and “WIP” may be used herein, other isostatic presses are contemplated for use with the disclosed embodiments. An isostatic press, including a WIP, generally involves application of a uniform pressure onto every surface of an object using a pressurized fluid. As the cell stack defines relatively large parallel planar surfaces and relatively small dimension side walls extending between the planar surfaces, the pressurized fluid of the WIP primarily applies opposing forces on the planar surfaces of the stack, thereby laminating the layers of the stack and/or densifying the material of the stack layers. Pressing the cell stack with the uniform opposing pressure of a WIP device may allow for a more consistent lamination and may help avoid cracking tied to non-uniform force. Further, large WIP units may also be viable for mass production by applying pressure to several cell stacks at the same time, increasing the efficiency of cell manufacturing.

Although the use of WIP to pressurize a cell pouch has some benefits, many challenges may arise. For example, the WIP may require additional cell preparation and cleanup, including the need for cells to be individually packaged if the pressure is not applied to the standard material of the cell, which adds to cell preparation and post-press processing time while also increasing consumable cost. In addition, many WIP devices use water as the fluid within the device that applies pressure to the cell stack. However, contact with cell leads by water needs to be avoided to ensure damage to the cell leads is avoided. Secondary pouching or reliable masking of the metal tabs may therefore be considered. In other instances, an oil may be used as the fluid of the WIP, which would require clean up after processing.

If a cell stack, without more, is processed in a WIP, it may cause mechanical damage to the battery, resulting in shorter battery life or potential for a short within the battery itself. For example, the WIP applies pressure equally to all surfaces. However, the edges and sides of the cell stack, without protection, may be susceptible to damage at high pressures. Similarly, without protection, pressure applied to the tab and/or weld areas of the cell pouch may also be more susceptible to damage due to high pressure.

Aspects of the present disclosure involve systems and methods of producing a solid-state battery cell using an isostatic press system to apply a substantially uniaxial load on the flat surfaces of the cell, while limiting or eliminating the pressure applied to the sides and outside of the cell to minimize or reduce damage to those portions of the cell. In some arrangements, the substantially uniaxial force is perpendicular to the large planar surface(s) of the cell and portion of the cell being laminated or densified. In addition or alternatively, the systems and methods described herein provide for applying such substantially uniaxial pressure to multiple cell stacks simultaneously for efficient cell manufacturing and for the use of water in the isostatic press in a safe and efficient manner. In one implementation, a cell housing, configured for the number, size and thickness of cells to be processed, is provided that includes one or more receptacles for battery cells. The receptacles of the housing may have a shape and depth such that individual battery cells or some portion thereof may lie within a respective receptacle such that the relatively short sidewalls of the battery cell are protected by the receptacle, one of the planar surfaces of the cell stack is on a floor of the receptacle and the opposing planar surface is exposed to the fluid within the isostatic press. The housing and the cell structures within the receptacles may be placed in a sleeve and the sleeve vacuum sealed over the housing and cells. In this way, the cell is protected from fluid within the isostatic press. Further, the sleeve may be in contact with the portion of the cell meant to receive pressure and force from the WIP, while also blocking fluid from contacting the sidewalls of the cell structure. As such, when processed in the isostatic press, the side walls are protected and the pressure of the fluid within the isostatic produces a force on the surface of the stack with the opposing surface pressed into the floor of the receptacle. The fluid in contact with the surface of the cell stack or the sleeve encompassing the cell stack produces a substantially uniaxial force across the surface when the fluid in the press is pressurized. The distributed force is uniform due to the nature of the isostatic press. The uniaxial force is substantially perpendicular to the surface, which in some arrangements means that the force is also perpendicular to the surface surrounding the receptacle and cell structure, as such the force applies a distributed relatively uniform laminating force to the cell stack. As noted, the force may also densify layers of the cell stack. The sleeve also bridges over small gaps where the sidewalls of the cell may be exposed and thus blocks fluid and the pressure from the same from entering and applying forces into those areas thus restricting the force to the areas where it can laminate and/or densify.

In instances in which the cell stack includes tabs extending from the stack, the respective receptacle may include a portion to receive and isolate the connection tab. Various tab configurations are possible and the receptacles may be shaped according to the size and type of cell stack to be processed, including accommodation various alternative tab arrangements and use of pouched or unpouched cell stack. In one configuration, any given receptacle includes two tab portions each dimensioned such that the tabs may be positioned in the tab portion and each tab is slightly above a tab portion floor such that the tab “floats” in the tab portion-the tab is surrounded by a side wall of the tab portion but is not supported on the floor.

Further, the housing may include receptacles on a top side and a bottom side (e.g., pouch cells in receptacles directly opposing each other) to increase the number of cells held by the housing. The opposing receptacles are separated by a mutual planar floor upon which the opposing cells within the opposing receptacles rest. The floor provides an opposing force, on the surface of the cell pressed into the floor, to the force on the opposing surface of the cell from the pressurized fluid of the isostatic press, and the floor also may help prevent warping of the cell as a flat surface of the cell is pressed into the corresponding flat surface of the floor.

Once the housing receptacles are loaded with the cell stacks, the housing may be inserted into a flexible and formable container, referred to herein as a sleeve, and vacuum formed and sealed over the housed pouch cells. The sleeve may have at least one opening into which a housing may be inserted. The sleeve, while described as enclosing the housing and vacuum sealable, the sleeve may be a layer or sheet that is applied to one or more surfaces of the housing to block fluid from reaching a cell within a receptacle of the housing. The sleeve may prevent the fluid of the isostatic press from contacting or damaging the cells. Further, the sleeve material, after vacuum forming or otherwise sealing, is formed over the cell stacks and housing such that when placed within the isostatic press, the uniform pressure within the isostatic press may apply a uniform pressing force through the sleeve material to the portions of the cell. Due to the flexible nature of the sleeve, the force on the sleeve is translated to the cell in places where the sleeve is contact with the cell. The housing provides a structure for applying a substantially uniaxial load on the flat surfaces of the internal cell structure, through the opposing flat sides of the cell stack and the sleeve, while limiting the potentially damaging pressure applied to the sides and outside of the cell stack. In addition, the sleeve may prevent damage to the cells from the fluid of the isostatic press while also removing the need to clean the fluid off the cells after processing within the isostatic press. While much of the discussion thus far refers to a housing with back-to-back receptacles and a floor therebetween, embodiments are described herein that support a cell within a receptacle such that the pressurized fluid of the isostatic press applies force to the opposing planar surfaces of the cell stack within the receptacle.

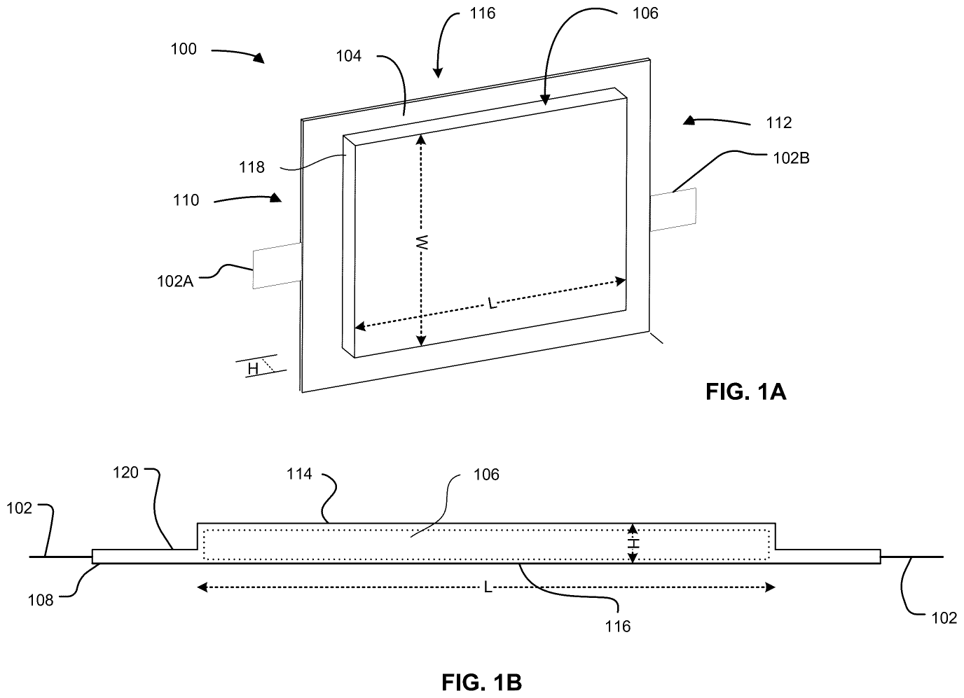

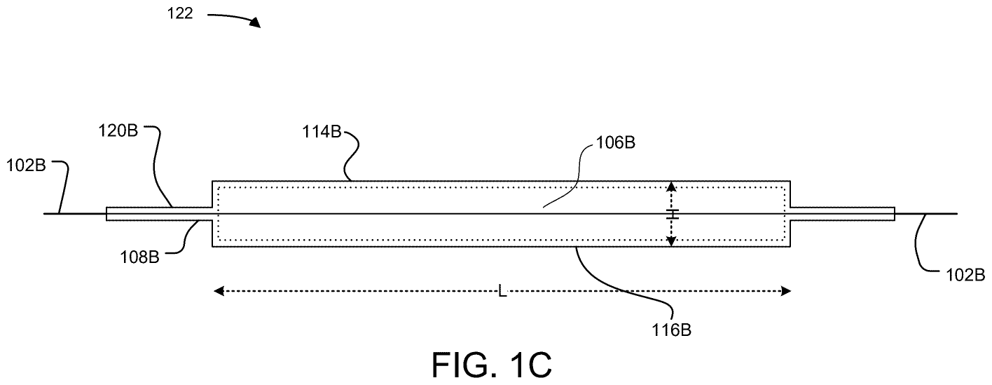

The composition of the cell stack which may be pressurized through the isostatic press described herein may take many forms. FIG. 1A is an isometric view of one possible example of a conventional pouch cell 100 for use with the isostatic press. Although described herein as applying to a conventional pouch cell 100, it should be appreciated that the devices, systems, methods, and the like described herein may equally apply to unpouched cell stacks. For example, the isostatic press may be used with cell stacks which are then used in prismatic cells. In general, the systems and methods described herein are not limited to pouch cells, but such cells may be used as an example for use with the implementations described herein.

In this example, the pouch cell 100 is generally rectangular in shape with conductive tabs 102 extending from opposing ends of the pouch cell. The conductive tab 102A extending from one end of the pouch cell is connected with the anode of the electrochemical cell inside, typically at a current collector, and the conductive tab 102B at the other end of the pouch cell is connected with the cathode of the electrochemical cell 106, also at a current collector. Pouch cells may be of varying configurations including different shapes, such as the shape of a rectangle or square in possible examples. In the example illustrated in FIGS. 1A and 1B, the pouch cell 100 includes a sealed rectangular periphery 104 around the enclosed battery cell 106. The sealed periphery 104 is located where the outer flexible pouch material layers extend beyond the encapsulated area of the layered cell structure, such as electrochemical cell 106, within the bonded and sealed layered structure of the pouch.

FIGS. 1A and 1B illustrate a lower sheet 108 as planar and the electrochemical cell structure 106 is on the sheet and projecting upward from the sheet. An upper sheet 120 is placed over the cell structure and the upper and lower sheets are bonded along the periphery 104. The pouch cell has an overall length and width with a portion 118 encapsulating the cell structure 106 having a length (L) and a width (W) each less than the overall length and width of the pouch cell due to the periphery 104, as well as the tabs if considered part of the length. The portion 118 also includes a height (H). In this example, the conductive tabs 102 are located at opposing ends of the pouch cell. The cell has a first surface 114 and a second surface 116. Both surfaces are planar, and the distributed force from the isostatic press is applied to one or both surfaces. In some embodiments, one or the other surface is positioned against a floor of a receptacle of the housing and the opposing surface is exposed to force from the pressure of the isostatic press. In general and in some embodiments, the receptacle is configured to position the cell so that the forces from the press are applied perpendicular to the surface(s) 114 and/or 116. It should be noted that the top surface 114 may include the entire top sheet 120 including the area of the flexible pouch material that extends beyond the edges of the electrochemical cell 106. In some embodiments, the receptacle is dimensioned such that force is not applied to the tabs. In some embodiments, the receptacle is further dimensioned to include a pocket dimensioned slightly larger than the length (L) and width (W) of the portion 118 of the pouch encapsulating the cell 106 to protect the side walls of the portion 118, and hence the sides of the enclosed cell 106, from forces within the press. If the structure is protected with a sleeve during processing, the sleeve bridges the gap between the edge of the pocket and the portion 118 thereby blocking fluid from the sidewalls of the portion 118. In this example conductive tabs 102 are located in a lower plane relative to height (H) dimension. It should be noted that conductive tabs 102 could be located at any suitable height (H) dimension in various possible embodiments of the present disclosure. The tabs may also extend from the same side or may extend from pouch cell in other ways to conform to whatever end use for the pouch cell. FIG. 1C is another example of a pouch cell similar to the example of FIGS. 1A and 1B, with the primary distinction that the tabs 102 extend from about a midpoint of the encapsulated cell 106 as opposed to along the planar bottom surface of the cell. The conductive tabs 102A,B in this implementation are located in a plane that corresponds to about the middle of the height (H) dimension of the pouch cell. It should be noted that conductive tabs 102A, 102B could be located at any suitable height (H) dimension in various possible embodiments of the present disclosure.

Regardless of if the type of pouch cell used, the stack of layers of material of the internal cell structure 106 may be laminated using a housing and an isostatic press, as well as a sleeve in various possible different embodiments. As noted, while discussed relative to a pouched cell, the isostatic process and devices described herein may be used to laminate a cell stack prior to pouching, densify discrete cell components such as an anode or cathode or combinations of the same, among other uses where lamination and/or densification of an electrochemical structure would be beneficial. In some instances, the isostatic press is filled with a fluid, such as water or oil, that is pressurized to apply a pressing force to the submerged and housed cell structure between 20k-60k pounds per square inch, in some embodiments. One additional advantage of using a sleeve is that the cell is protected from exposure to whatever the fluid used in the press. In addition, the fluid may be warmed up to 90 degrees Celsius, which may be considered a warm isostatic press or WIP. The combination of warmth and pressure may be further beneficial for lamination of the layers. As noted, the system may also densify the layers, or further densify the layers if the cell structure was densified prior to processing in the isostatic press. Also, as noted, in some instances, the cell pouch may be inserted into a fluid-proof pouch (sleeve) or otherwise includes a barrier to prevent the water or oil from contacting the cell pouch.

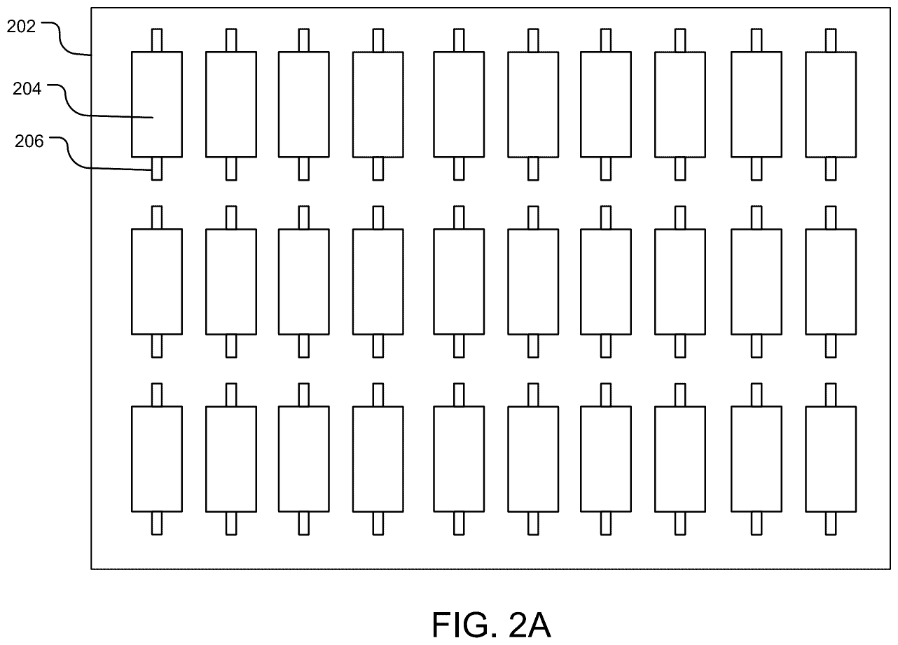

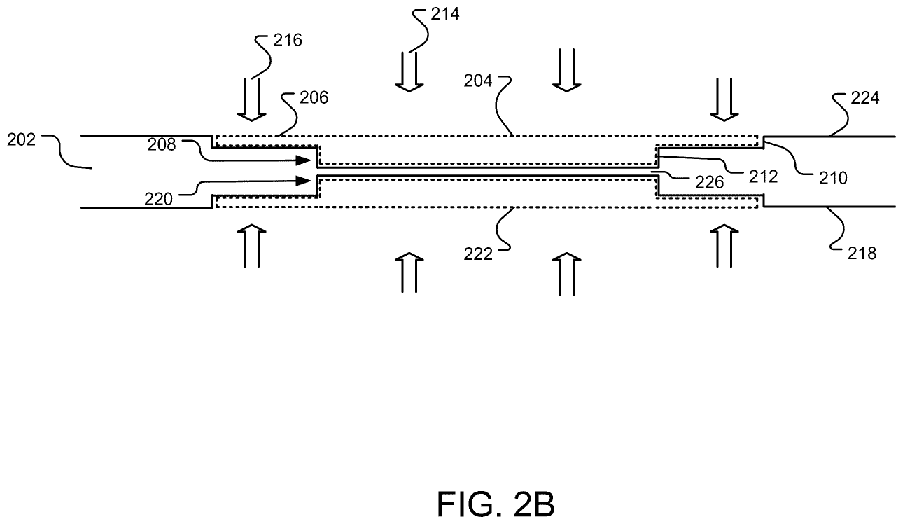

FIGS. 2A and 2B illustrate a housing for use with a WIP to apply a substantially uniaxial pressure to a plurality of pouch cells to reduce the pressing damage on the cells from the isostatic pressure of the WIP. In particular, FIG. 2A is a representative top (overhead) view of a housing including a shaped receptacles for housing pouch cells where the substantially uniaxial pressure from the isostatic press may be applied to the pouch cells when the housing is placed in the isostatic press and it is pressurized. FIG. 2B side section view of a receptacle of the housing. In general, the housing 202 is a rigid or semi-rigid housing comprising one or more receptacles for receiving a cell pouch 204 or cell pouch. In some instances, the receptacles of the housing 202 may include a portion for one or more tabs 206 of the cell pouch 204. As shown in FIG. 2A, the housing 202 may be rectangular in shape with several receptacles. Although the housing 202 is illustrated as including receptacles for 30 cell pouches 204 (three rows of ten receptacles), the housing may be shaped to include any number of receptacles, including one receptacle. In addition, the top of the housing 202 may be a shape other than rectangular, including circular, square, cross-shaped, or any other shape.

The cross-section view of the housing 202 of FIG. 2B best illustrates the receptacle 208 inset into the housing 202 to accommodate the cell pouch 204 (illustrated as a dashed line in FIG. 2B). In the example shown, the receptacle 208 may include a first, in this example center, rectangular portion 212 shaped to accommodate the cell portion 106 of the cell pouch. For cell pouches with other shapes, the center portion 212 of the receptacle 208 may be shaped to accommodate the shape of the cell pouch 204. With a pouch having tabs extending to only one side (as opposed to opposing sides), the portion receiving the greater height (H) portion of the cell pouch may not be centered between the portions, to be discussed below, that receive the tabs.

The length and width of the portion 210 are each slightly larger than the length and width of the stack portion of the pouch cell to be processed within the housing. In various examples, the length and width of the relatively deeper portion of the receptacle may be about 1 mm to about 5 mm larger than the respective length and width of the cell to be processed. Other dimensions are possible noting that it may be dimensioned such that pressure does not damage the side walls and such that pouch cells may be easily placed and removed from the receptable.

The depth of the center portion 212 of the receptacle 208 may be such that a surface of the cell pouch is aligned with a surface of the surrounding housing. In another example, a surface of the cell pouch extends above the height of the housing 202 by some amount. However, to reduce the amount of pressing force on the sides of the cell pouch 204, the depth of the receptacle 208 should be such that the majority of the cell pouch is retained within the receptacle. In yet another example, a surface of the cell pouch is slightly offset below a surface of the surrounding housing. Regardless, when positioned within a receptable, a surface of the cell pouch exposed to the WIP fluid receives pressure.

In cell pouches with one or more electrode tabs 206, a portion 210 of the receptacle 208 may extend from one or more ends of the center portion 212. For example and as shown in the top view of FIG. 2A, the cell pouch 204 may include one or more electrode tabs 206 that extend from opposing ends of the cell pouch. The tabs 206 may provide connection points to the layers within the cell pouch 204, such as connection to the anode of the cell pouch and/or a connection to the cathode of the cell pouch. In the particular embodiment of FIG. 2B, the extending portion is dimensioned with a depth of about the height of the cell tab such that one surface of the cell tab is on the surface of the receptacle and the opposing surface is at about the surface of the housing surrounding the receptacle. Similar to the center portion 212 of the receptacle 208, the extending portion 210 of the receptacle may have a depth such that the tabs 206 of the cell pouch 204 are completely within the receptacle or extend slightly above the receptacle. In this manner, the extending portions 210 of the receptacle 208 may be shaped to accommodate the shape and size of the tabs 206 of the cell pouch 204. Here, when the WIP is pressurized, only the exposed surface of the tab is pressurized, and the tab is otherwise supported in the extending portion of the receptacle.

The cross-section view of the housing 202 also illustrates that receptacles 208 may be located on the opposing or bottom side 28 of the housing 202, although some housing may include receptacles on only one side of the housing. The bottom side receptacle 220 may be a mirror image of the top side receptacle 208 to accommodate a second cell pouch 222 on the bottom side 218 of the housing 202. In some instances, each top side receptacle 208 may include a corresponding bottom-side receptacle 220, thereby doubling the cell pouch capacity of the housing. In other instances, the bottom side 218 of the housing 202 may include more or fewer receptacles as the top side 224 of the housing. Further, the bottom side receptacles 220 may be the same shape or a different shape as the top side receptacles 208. In some instances, a mix of various receptacle shapes may be included in both or either the top side 224 of the housing 202 or the bottom side 218 of the housing.

Through the use of the housing 202 in an isostatic press device, several advantages may be achieved. For example, more traditional isostatic press applies pressure to sides of the pouch cells, in addition to the top and bottom surfaces, which could induce damage to the edges. In contrast, by the shape and form of the receptacle of the housing 202, the pressure in the isostatic press may apply a substantially uniaxial force 214 across the cell pouch 204 while reducing or eliminating pressing forces on the edges or smaller sides of the cell pouch. As shown in FIG. 2B, the isostatic press may apply a uniform pressing force 214 along the exposed side of the cell pouch 204 when the fluid within the WIP is pressurized. A non-isostatic counterpressure is applied by the surface of the housing receptacle 212 to the cell pouch 204. In addition, as the housing 202 provides for back-to-back receptacles for the pouch cells 204, 222, the housing material 226 between the top side receptacle 208 and the bottom side receptacle 220 does not need to be particularly thick as the cells on both sides will press on the housing with equal force. This layer 226 between the top side receptacle 208 and the bottom side receptable 220 may provide dimensional stability to the loaded cells 204, 222 during pressing by the WIP. Such dimensional stability may aid in reducing or preventing warping that is possible during in cells during unsupported isostatic pressing.

In general, the pressure 214 on the pouch cells 204, 222 when housed in the receptacles 208, 220 will be uniform, but primarily uniaxial, across the pouches with little pressure on the corners or sides of the pouch cells to avoid mechanical damage. Circumstances in which the pouch cells 204, 222 include connection tabs 206, a uniaxial force 216 may still be applied to the connection tabs. However, the support provided by the housing 202 to the connection tabs 206 when located within the receptacles 208, 220 may prevent damage to the tabs from the pressing force 216 of the WIP. In this manner, the housing 202 achieves the pressure uniformity of the WIP device while only applying pressure to the top and bottom surfaces of the cell pouch 204, 222 as is done with uniaxial pressing to avoid mechanical damage to the cell pouches.

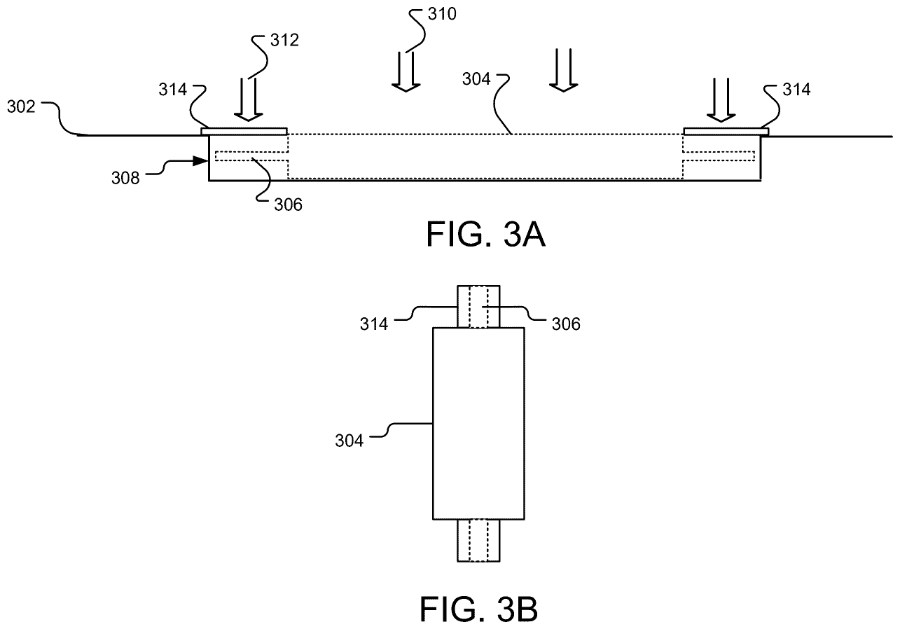

FIG. 3A is a cross-section view of a receptacle of a second housing for applying substantially uniaxial pressure to a plurality of solid-state battery cells within an isostatic press, according to aspects of the present disclosure. In this implementation, the housing 302 may include a generally prismatic receptacle 308 in which a cell pouch 304 may be placed. The prismatic receptable 308 may receive cell pouches of various shapes and sizes. For example, a rectangular cell stack (without connection tabs) may be located within the receptable 308. In another example, a cell pouch 304 with connection tabs 306 may similarly be located within the receptacle 308. In general, the receptacle 208 may be shaped to accommodate the shape of the cell pouch 304. As above, the length and width of the receptacle 308 are slightly larger than the length and width of the stack portion of the pouch cell to be processed within the housing. In various examples, the length and width of the receptacle 308 may be about 1 mm to about 5 mm larger than the respective length and width of the cell to be processed. In general, the depth of the receptacle 308 may be such that a surface of the cell pouch 304 is aligned with a surface of the surrounding housing. In another example, a surface of the cell pouch extends above the height of the housing 302 by some amount. The uniaxial pressure 310 from the isostatic press may therefore be applied to the large surface of the cell pouch 304 when located within the receptacle. However, to reduce the amount of pressing force on the sides of the cell pouch 204, the depth of the receptacle 308 should be such that the majority of the cell pouch is retained within the receptacle. In yet another example, a surface of the cell pouch is slightly offset below a surface of the surrounding housing. Regardless, when positioned within a receptable, a surface of the cell pouch exposed to the isostatic press fluid receives pressure 310.

In some implementations, a cell pouch 304 with connection tabs 306 may be located within the receptacle 308. To prevent the pressure force 312 of the isostatic press from damaging the tabs 306, a mechanical support in the form of a cover 314 or other protective structure may be positioned over the tabs and the portion 308 of the receptacle receiving a tab. The covers may be provided in a variety of ways. For example, a corrosion resistant metal sheet having rectangular cut outs corresponding to the size of the cell structure 106 and aligned with the corresponding receptables may be form a cover over the tab portions of the receptacles when the sheet is positioned over the housing. The sheet may be a separate structure, or hinged to provide a clam shell to close over the receptacles and capture the pouch cells positioned in the receptacles or unload the same after lamination and/or densification. The shape of the cut outs allows the isostatic pressure to be applied to the cell structure. As shown in FIG. 3A, the protective cover 314 may be attached or otherwise supported by the housing 302 to be retained in place above a corresponding tab 306 to prevent the pressure force 312 of the WIP from pressing onto the tab. Rather, the pressure force 312 may be applied to the protective strip 314 such that the pressure on the tabs 306 and/or the sides of the cell pouch 304 is reduced. FIG. 3B is an overhead view of a solid-state battery cell 304 with a tab protection strip 314 located over the tabs 306 of the cell pouch. The protective strips 314 may prevent or reduce a pressure force 312 of the WIP from damaging the tabs 306 and/or sides of the cell pouch 304. In some instances, the protective strips 314 may be removably attached to the housing 302 such that the strips may be detached from the housing during loading of the cell pouch 304 and reattached once the cell pouch is loaded. Any cover over the tab receptacles may also provide a support surface for the sleeve so that the sleeve is supported from and does not deform or not overly deform down on the tabs when the press is pressurized. In the embodiment with cut outs, the cut out size may be of the about the width (W) and length (L) of the cell portion 118 to provide a support surface over the gap between the sidewalls and the receptacle, particularly if the receptacle is a bit oversized to provide ease of loading of the pouches, with the support surface over the gap similarly supporting the sleeve from deforming down into the gap area.

As noted above, the housing along with pouch cells loaded into receptacles, may be enclosed in a flexible resilient formable container, such as a sleeve. The sleeve may be evacuated and sealed to the housing and receptacles prior to processing in the isostatic press.

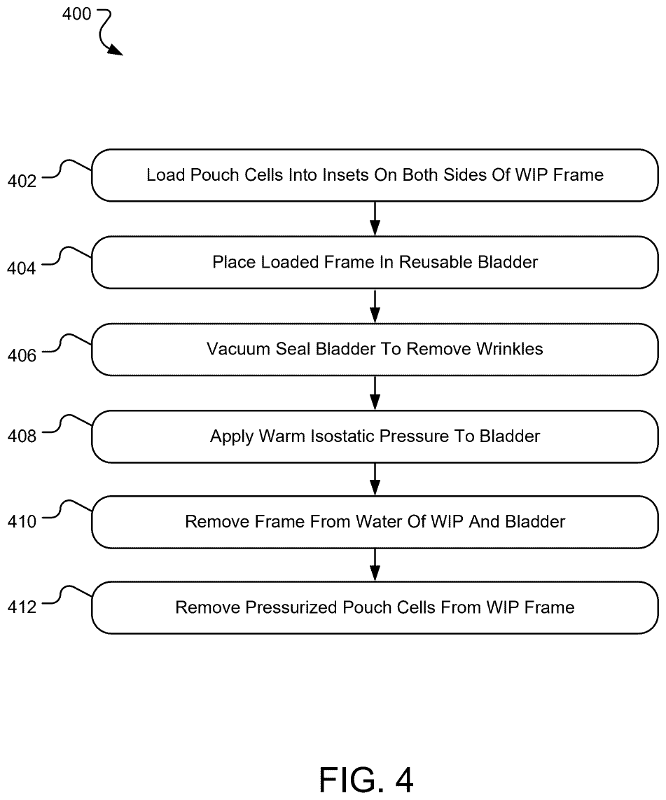

FIG. 4 is a flowchart of a method for utilizing a housing 202 for applying uniaxial pressure to a plurality of pouch cells within an isostatic press. At step 402, one or more pouch cells may be loaded into insets or receptacles of the WIP housing 202. Although described herein as use with pouch cells, it should be appreciated that other cell types may be used with the housing 202, such as completed cells, unpouched cell stacks, stacks within an interim enclosure, and the like. In general, any stack of layers of a cell may be loaded into the receptacles of the housing 202. For a housing 202 with corresponding receptacles 208, 220 on opposing sides of the housing, the pouch cells 204, 222 may be loaded into both sides of the housing. As noted above, the housing receptacles 208, 220 may be shaped and sized for the type of cells being loaded, including cells with or without connecting tabs. In general, the receptacles 208, 220 may be sized (e.g., have a shape and depth) such that the surface of the pouch cell extends only slightly above the outer surface of the housing 202 to minimize or reduce the pressing force applied to the sides/edges of the cell pouches.

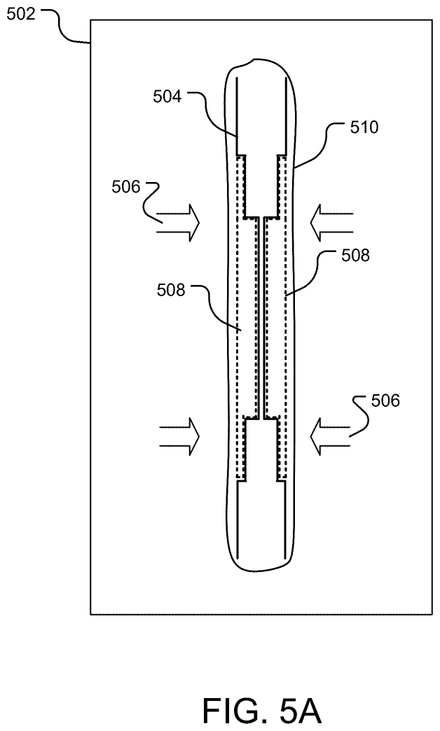

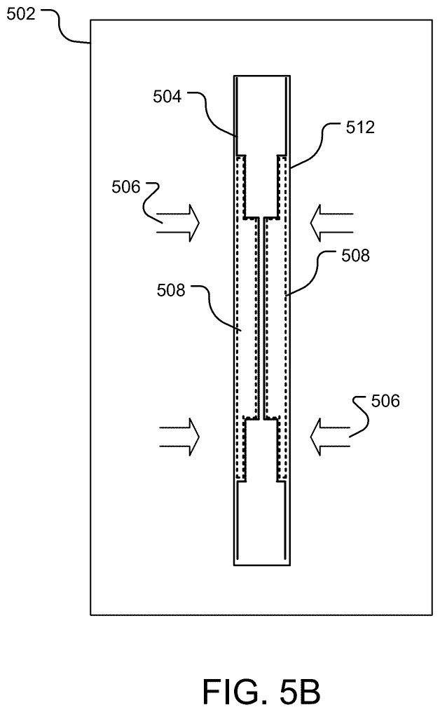

At step 404, the housing 202 with the loaded pouch cells may be inserted into a waterproof and sealable sleeve. The sleeve may therefore include a sealable opening through which the housing 202 may be inserted and sealed within the sleeve. The sleeve may be constructed of a water-proof material, such as plastic, polymer, nylon, polypropylene, polyester, polyamine or silicon rubber, or any other flexible, resilient liquid-impervious, material to prevent water or other fluids of the WIP from entering the sleeve. In some instances, the sleeve may be a multilayer sleeve where various polymers and even thin metal foils can be stacked together for preventing the fluids of the WIP from entering the sleeve. For example, FIG. 5A illustrates two pouch cells 508 loaded into the housing 504 and placed inside a sealable, fluid-proof sleeve 510 for use with a WIP 502. Although only two pouch cells 508 are illustrated in FIG. 5A, it should be appreciated that the housing 504 may include any number of pouch cells (as discussed above) and the entirety of the housing may be included within the sleeve 510. As such, only a portion of the housing is illustrated in FIG. 5A within the fluid-proof sleeve 510.

At step 406, the sleeve 510 may be vacuum sealed with the housing 504 in the sleeve. In some instances, the vacuum sealing of the sleeve 512 may be conducted to ensure that wrinkles are not present on the sleeve, particularly over the loaded pouch cells. Wrinkles in the sleeve during pressing may disrupt the uniform pressure applied to the pouch cells such that care may be taken to remove wrinkles in the surface of the sleeve. Further, the sleeve may be, in some instances, a reusable sleeve for use in densifying and/or laminating multiple pouch cells over time while reducing waste in comparison to a single-use sleeve. An example of the vacuum-sealed sleeve is illustrated in FIG. 5B. In particular, the sleeve 510 of FIG. 5A is illustrated in FIG. 5B as vacuum-sealed sleeve 512. Through the vacuum-sealing, the sleeve 512 may conform to the shape of the housing 504 to reduce wrinkles in the sleeve for more even application of the pressure forces 506 on the cell pouches 508 loaded into the housing.

At step 408, the loaded housing 504 sealed within the sleeve 512 may be placed within the WIP 502 and warm isostatic pressure may be applied to the cell pouches within the housing. As described above, the WIP 502 may densify the layers of the stack of the cell and/or at least partially laminate the layers together through application of pressure force 506 on the cell pouches 508. The sleeve 512 isolates the pouch cells 508 from the working fluid of the WIP 502 thereby allowing for the use of water, which is often less expensive and easier to clean compared to oil. After application of the pressure 506 to the pouch cells 508 from the WIP 502, the sleeve 512 and housing 504 may be removed from the fluid of the WIP at step 410. The sleeve 512 may be unsealed and the housing 504, with the pressed cell pouches 508, may be removed from the sleeve. At step 412, the pressurized pouch cells 508 may then be removed from the housing 504. As the sleeve maintains a barrier between the cell pouches and the fluid of the WIP 502, the cells can be removed from the housing 504 after pressing with no cleanup or de-masking. This may improve the speed at which densification and/or lamination of the layers of the pouch cells 508 is completed as the need to clean the pouches post pressurization may be removed from the process. In addition, the multiple receptacles of the housing 504 allows for densification and/or lamination of multiple cells to occur at once, further streamlining the cell manufacturing process, without damaging portions of the cell due to isostatic pressure on the edges or small surfaces of the cells. Further still, the sleeve 512 may aid in enabling the quasi-uniaxial pressure to the cells as it prevents the fluid of the WIP from reaching and imparting force on the sides of the cells that may occur without the housing/sleeve configuration.

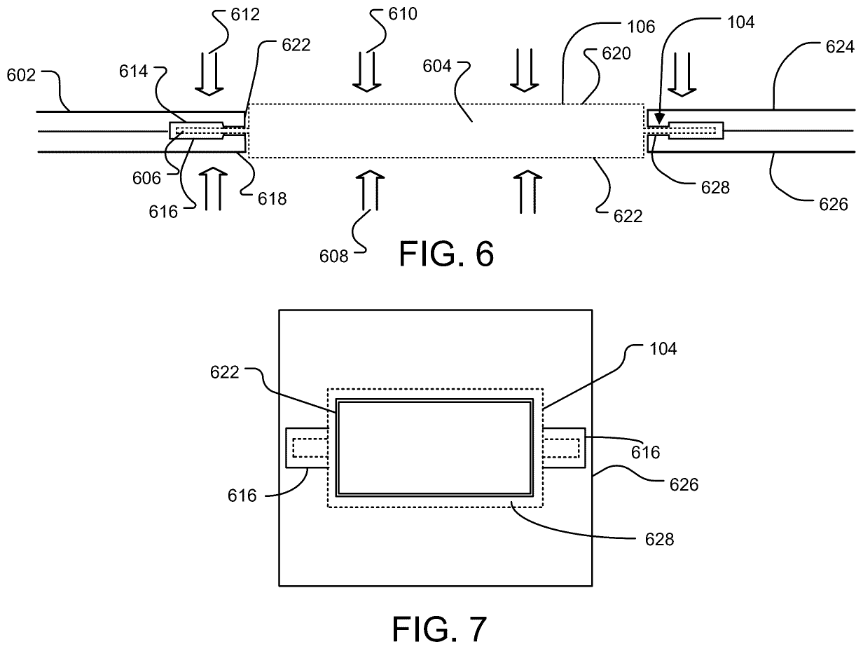

FIG. 6 is a diagram illustrating a cross-section view of a housing 602 for holding a solid-state battery cell within an isostatic press such that a pressure force is applied to a top and bottom region of the solid-state battery cell, according to aspects of the present disclosure. FIG. 7 is a top view of the housing of FIG. 6. In this embodiment, the housing 602 may include an opening 622 through the housing 602 such that a top surface 620 and a bottom surface 622 of the cell 604 receives a pressing force 610 from the isostatic press (as described above) simultaneously. The opening defines a shape corresponding to the portion 106 of a pouch cell 604 that contains the internal cell stack. In the illustrated example, the opening is rectangular corresponding to the rectangular shape of the pouch cell.

In contrast to the implementations above, the housing 602 does not include a receptacle with a bottom surface on which the cell 604 sits but is instead open on both sides of the housing such that the top surface 620 and the bottom surface 622 of the cell receive the pressing force 608, 610 of the press. Both the pressing forces are substantially perpendicular to the surfaces and extend across the exposed surfaces. Thus, opposing uniaxial forces 610, 608 are applied on the opposing top surface 620 and bottom surface 622 of the cell 604.

To load the pouch cell and hold the pouch cell within the housing, the housing may include a first (e.g., upper) portion 624 and a second (e.g., lower) portion 626, which may be two separate pieces. The upper and lower portions may be hinged to open as a clam shell or otherwise interconnected. The pouch cell is placed in the rectangular opening with the portion 106 within the rectangular opening. Referring back to FIG. 1 as well as FIGS. 6 and 7, the sealed periphery 104 rests on a peripheral surface 628 of the housing surrounding the opening. At the tabs and to protect the tabs 606 and/or sides of the cell 604 in this configuration, the housing 602 may define recesses 614 and 616 that receive the tabs when the cell is placed in the opening. The recesses, like the opening, in any given implementation will be positioned and sized according to the type of pouch cell, location and size of the tabs. Therefore, when located within the receptacles, the tabs 606 of the cell 604 may be protected from pressing forces 612, 616 of the isostatic press as the stack within the cell is pressed through the pressing forces 610, 608 on the top surface 620 and the bottom surface 622 of the cell. When the top plate 624 is in place, the pouch cell is held in place along the periphery by the top plate and the bottom plate. So as to control or eliminate force on the periphery of the pouch, the upper and lower housings may have slightly offset peripheral surfaces around the opening such that when the upper and lower parts are positioned over the pouch and periphery, there is gap corresponding to the thickness of the pouch periphery. As shown in FIG. 6, the upper 620 and lower 622 surfaces of the cell may be slightly proud of the housing surrounding the cell.

In the manner discussed, the top portion and the bottom portion of the housing form the opening through the housing to retain the cell within the opening. After insertion into the sleeve as discussed above, opposing uniaxial pressing forces may be applied to both sides of the cell 604 and the electrode stack within the cell. During the pressing, the housing 702 and sleeve may protect the periphery of the cell and/or the tabs of the cell from damage from the pressure within the isostatic press.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly and synonymously “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others. The disclosure is not limited to various embodiments (examples, instances or aspects) given in this specification. Various modifications and additions can be made to the exemplary embodiments discussed without departing from the scope of the present invention. Accordingly, the scope of the present invention is intended to embrace all such alternatives, modifications, and variations together and in various possible combinations of various different features of different embodiments combined to form yet additional alternative embodiments, with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. The term “about” or “substantially” will be understood by persons of ordinary skill in the art and will vary to some extent on the context in which it is used. As used herein when referring to some characteristic, a measurable value such as an amount, a temporal duration, and the like, the term “about” is meant to encompass variations of ±10%, including ±5%, ±1%, and ±0.1% from the specified value or characteristic, as such variations are appropriate to perform the disclosed methods. For example, being substantially uniaxial allows some deviation from perfectly uniaxial, such that the pressure from the isostatic press applies uniaxial forces on the cell but those forces may not be perfectly uniaxial and some or all or portions thereof may deviate by ±5%, ±1%, and ±0.1%.

Without intent to limit the scope of the disclosure, examples of instruments, apparatus, methods and their related results according to the embodiments of the present disclosure are given. Note that titles or subtitles may be used in the various embodiments for convenience of a reader, which in no way should limit the scope of the disclosure.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

What is claimed is:

1. A method for applying force to layers of an electrode of a battery cell, the method comprising:
loading a first cell stack comprising a plurality of layers into a first receptacle of a housing, the receptacle shaped to receive and support the first cell stack; and
pressurizing, through an isostatic press, the first cell stack, the isostatic press applying a uniaxial pressing force across the cell stack.

2. The method of claim 1 wherein the first receptable is on a first side of the housing and a second receptable is on a second side of the housing, the first side of the housing opposite the second side of the housing, the first receptacle separated by a planar wall from the second receptacle, the method further comprising loading a second cell stack in the second receptacle, and pressurizing, through the isostatic press, the first cell stack and the second cell stack, the pressurizing providing the pressing force across the first cell stack and the second cell stack for at least one of lamination and densification.

3. The method of claim 1 wherein the receptacle of the housing comprises an opening through the housing, and wherein the cell stack comprises a first surface that receives the uniaxial pressing force and a second, opposing surface, and pressurizing the first cell stack through the isostatic press further comprises applying an opposing uniaxial pressing force across the second opposing surface.

4. The method of claim 1 wherein the housing comprises a plurality of receptacles on a first side of the housing and a second plurality of receptacles on a second side of the housing, the first side of the housing opposite the second side of the housing.

5. The method of claim 4 wherein each of the plurality of receptacles on a first side of the housing align with a corresponding one of the second plurality of receptacles on the second side of the housing, the plurality of receptacles on the first side of the housing separated by the second plurality of receptacles on the second side of the housing by a planar layer of the housing.

6. The method of claim 1 wherein the first cell stack further comprises a cell body and a connection tab extending from the cell body, the first receptacle of the housing including a portion shaped to receive and support the connection tab.

7. The method of claim 1, further comprising:
covering at least a portion of the housing including the first receptacle and the first cell stack with a fluid-proof sleeve prior to pressurizing the cell stack.

8. The method of claim 7, further comprising:
vacuum sealing the housing within the fluid-proof sleeve.

9. The method of claim 1 wherein a majority of the first cell stack lies beneath an outer surface of the housing when loaded within the receptacle of the housing.

10. The method of claim 1 wherein pressurizing the first cell stack at least partially laminates two or more of the plurality layers of the cell stack.

11. The method of claim 1 wherein the isostatic press is a warm, isostatic press device.

12. An apparatus for applying force to a battery cell, the apparatus comprising:
a housing comprising a first receptacle, the first receptacle shaped to receive a first cell stack, the housing configured to be positioned within an isostatic press, the receptacle further shaped to orient the first cell stack such that a substantially uniaxial force will be applied across a surface of the cell stack when the isostatic press is pressurized.

13. The apparatus of claim 12 wherein the first receptacle is on a first side of the housing, and the housing further comprises:
a second receptacle on a second side of the housing, the first side of the housing opposite the second side of the housing, the second receptacle shaped to receive a second cell stack, the second receptacle further shaped to orient the second cell stack such that a substantially uniaxial force will be applied across a surface of the second cell stack when the isostatic press is pressurized.

14. The apparatus of claim 12 wherein the first receptacle includes a planar floor on which a surface of the first cell stack may be positioned, the planar floor providing a counter uniaxial force on the first cell stack when the isostatic press is pressurized.

15. The apparatus of claim 13 wherein the first receptacle on the first side of the housing aligns with the second receptacle on the second side of the housing.

16. The apparatus of claim 12 wherein the cell stack comprises a pouch cell, the first receptacle comprises a portion of a first depth dimensioned to receive a portion of the pouch cell to receive the uniaxial force and an extending portion dimensioned to receive a tab of the pouch cell.

17. The apparatus of claim 12, further comprising:
a fluid-proof sleeve, the fluid-proof sleeve sealable around at least a portion of the housing and the first receptacle to prevent the pressurized fluid of the isostatic press from contacting the first cell stack when loaded in the first receptacle.

18. The apparatus of claim 12 wherein the substantially uniaxial force is for at least one of laminating and densifying the first cell stack.

19. The apparatus of claim 13 wherein the housing comprises a plurality of the first receptacles and a plurality of the second receptacles.

20. The apparatus of claim 12 wherein the first receptacle comprises an opening in which the first cell stack is retained, the receptacle further shaped to orient the first cell stack such that an opposing substantially uniaxial force will be applied across a second opposing surface of the cell stack when the isostatic press is pressurized such that the substantially uniaxial force and the opposing substantially uniaxial force are applied to the first cell stack simultaneously.

21. The apparatus of claim 20 wherein the first cell stack is a pouch cell and the opening is dimensioned such a sealed periphery of pouch cell rests on a surface of the housing surrounding the opening of the receptacle.
